(19) United States
(12) Patent Application Publication
(10) Pub. No.: US 2016/0371619 A1
(43) Pub. Date: Dec. 22, 2016

(54) OBSTACLE REDUCTION BASED ON REAL-TIME VISITORS COUNT

(71) Applicant: Target Brands, Inc., Minneapolis, MN (US)

(72) Inventor: Robert F. Foster, Ramsey, MN (US)

(21) Appl. No.: 14/742,109

(22) Filed: Jun. 17, 2015

(51) Int. Cl. G06Q 10/06

(52) U.S. Cl. CPC G06Q 10/0637

(57) ABSTRACT

A system includes a counting subsystem that maintains a count of visitors currently in a location having aisles and an alert subsystem that monitors the count and that issues an alert to employees in the location in response to the count exceeding a threshold, wherein the alert instructs employees to remove obstacles from the aisles.

### BACKGROUND

In retail stores and public venues, pathways are provided to give customers access products and attraction areas. At times, employees will take certain actions, such as maintenance, cleaning or restocking, that require the employees to partially or fully block one or more paths in the retail store or venue. For example, carts can be used to bring products to shelves during restocking or equipment can be placed in the paths for cleaning or repairing an area.

The discussion above is merely provided for general background information and is not intended to be used as an aid in determining the scope of the claimed subject matter. The claimed subject matter is not limited to implementations that solve any or all disadvantages noted in the background.

### SUMMARY

A system includes a counting subsystem that maintains a count of visitors currently in a location having aisles and an alert subsystem that monitors the count and that issues an alert to employees in the location in response to the count exceeding a threshold, wherein the alert instructs employees to remove obstacles from the aisles.

In accordance with a further embodiment, a method includes determining a number of visitors in a store, selecting an alert threshold and comparing the number of visitors to the alert threshold. When the number of visitors exceeds the selected alert threshold, an alert broadcast to store employees to facilitate access to products on shelves in the store.

In accordance with a still further embodiment, a processor perform steps that include receiving an indication that additional visitors have entered a store, determining that the additional visitors cause a total number of visitors in the store to exceed a value, and in response, sending a message to store employees to make themselves available to assist visitors.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 provides a plan view of a retail store showing one environment in which embodiments may be practiced.

FIG. 2 provides a flow diagram of a method in accordance with one embodiment.

FIG. 3 provides a block diagram of elements used in the method of FIG. 2.

FIG. 4 provides a block diagram of a computing device.

### DETAILED DESCRIPTION

Embodiments described below count the number of visitors in a location and compare the count to an alert threshold. When the count exceeds the alert threshold, an alert is sent to employees of the location to remove obstacles from paths and aisles in the location so that it is easier for visitors to reach destinations and/or products. In some embodiments, the alert threshold is selected based on the time of day, the day of the week and/or the number of employees in the location. When the number of visitors in the location drops below the threshold, a new alert is sent to the employees to resume their activities such as restocking, cleaning and maintenance.

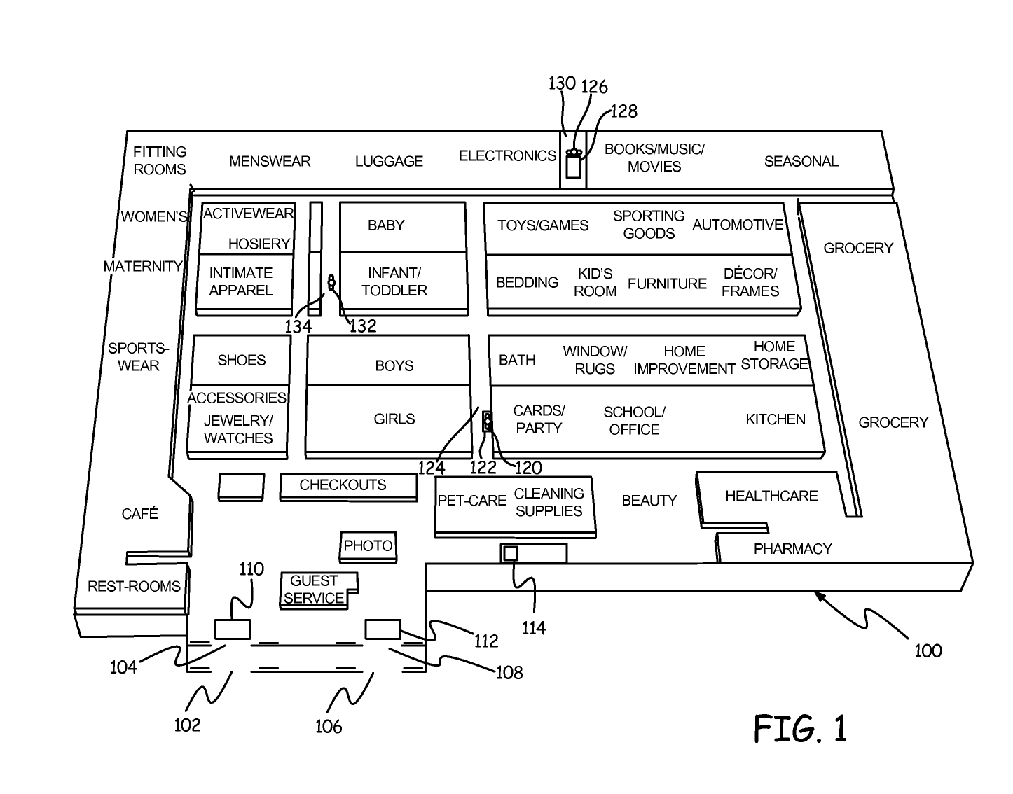

FIG. 1 provides a plan view of a location, also referred to as a venue, building or retail store 100. Location 100 includes entrance doors 102 and 104 and exit doors 106 and 108. Entrance door 104 and exit door 108 include respective people counting systems 110 and 112 that are able to count the number of visitors passing through entrance door 104 and exit door 108. People counters 110 and 112 can be thermal counting systems that use an array of sensors to detect heat sources and to determine a direction that a heat source is moving. Based on this movement information, people counters 110 and 112 can determine whether a visitor is entering or exiting through the respective entrance door 104 and exit door 108. In other embodiments, people counters 110 and 112 can comprise one or more cameras having computer vision algorithms that allow them to detect objects moving in a field of view and to determine whether the objects represent a visitor entering or exiting through entrance door 104 or exit door 108. People counters 110 and 112 are connected through a wired or wireless connection to a server 114 and as the count of the number of visitors entering and/or exiting location 100 changes, people counters 110 and 112 convey this information to server 114 so that server 114 has a real-time count of the number of visitors who have entered location 100 and the number of visitors who have left location 100.

Within location 100 are a plurality of pathways that visitors to location 100 can use to access different areas within location 100. When location 100 is a retail store, the pathways are referred to as aisles that provide customers access to shelves and other displays containing merchandise. For example, in FIG. 1 multiple aisles are shown including aisles 124, 130 and 134.

It is sometimes necessary for employees to partially obstruct or fully obstruct one or more paths within location 100 to perform certain tasks such as restocking, cleaning and maintenance. For example, in FIG. 1, an employee 120 has positioned maintenance equipment 122 in path 124, an employee 126 has positioned restocking equipment 128 in a path 130 and employee 132 is cleaning a path 134. In each case, the employee and/or the equipment the employee is using are partially or fully obstructing a respective path.

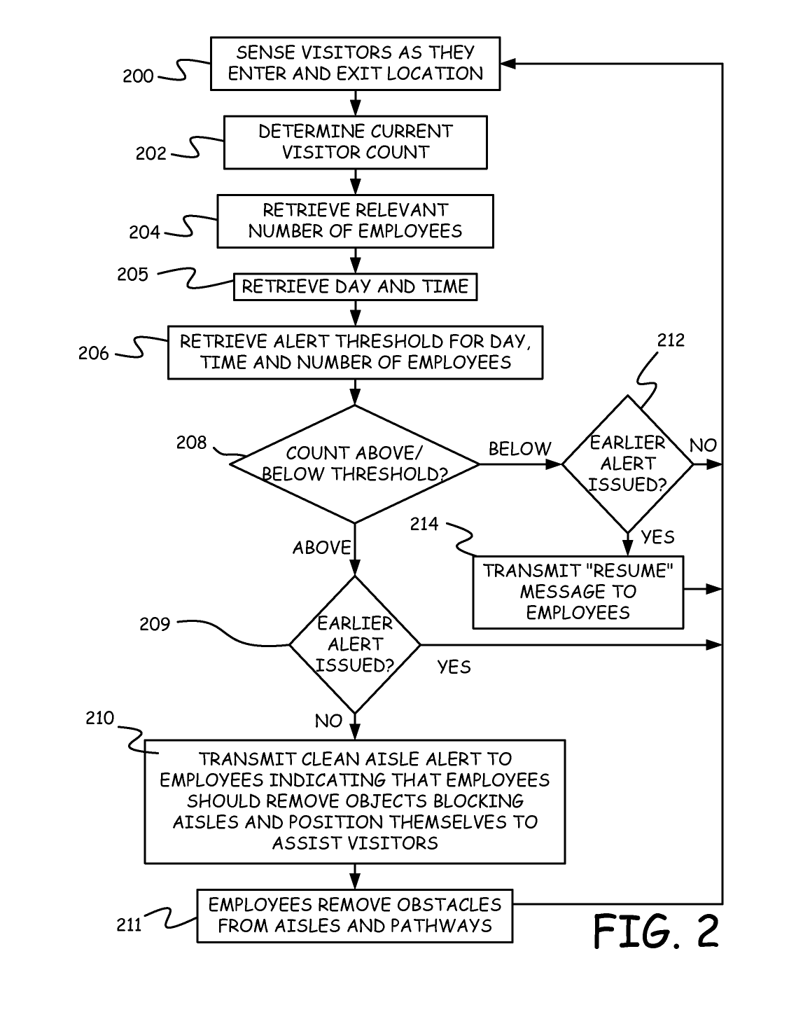

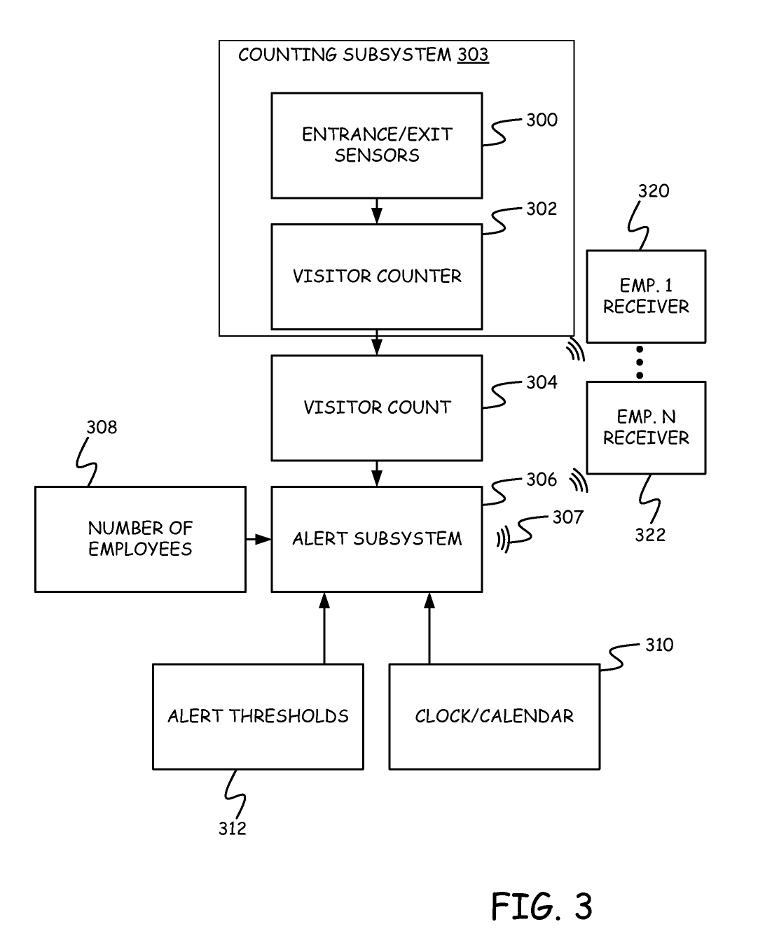

FIG. 2 provides a method in accordance with some embodiments and FIG. 3 provides a block diagram of elements used in the method of FIG. 2. In step 200, entrance/exit sensors 300, such as people counters 110 and 112, sense visitors as they enter and exit a location. Information from entrance/exit sensors 300 is provided to a visitor counter 302, such as server 114 of FIG. 1. Together, entrance/exit sensors 300 and visitor counter 302 form a counting subsystem 303. In some embodiments, the information provided by entrance/exit sensors 300 includes separate counts of the number of visitors who have entered and the number of visitors who have left since the last messages from sensors 300 were sent to visitor counter 302. In other embodiments, the information provided by entrance/exit sensors 300 is the difference between the number of visitors who have entered and the number of visitors who have exited through the entrance monitored by the entrance/exit sensor 300.

At step 202, visitor counter 302 combines the information it receives from the various entrance/exit sensors 300 to determine a current visitor count 304 representing the number of visitors in the location 100. For example, if visitor counter 302 receives counts of the number of visitors who have entered the location through a plurality of doorways and the number of visitors who have left the location through the plurality of doorways, visitor counter 302 sums the number of visitors who have entered the location through the plurality of doorways to form a total count of the number of visitors who have entered the location and sums the number of visitors who have left the location through the plurality of doorways to form a total count of the number of visitors who have left the location. Visitor counter 302 then subtracts the total number of visitors who have left the location from the total number of visitors who have entered the location to arrive at the total number of visitors in the location.

Visitor count 304 is provided to an alert subsystem 306, which in one embodiment is also within server 114. At step 204, alert subsystem 306 retrieves a number of employees 308 from a database containing the number of employees currently in location 100. At step 205, alert subsystem 306 retrieves the current day and time from a clock/calendar 310 wherein the day may be retrieved as the date and/or the day of the week.

At step 206, alert subsystem 306 retrieves an alert threshold from alert thresholds 312. In accordance with one embodiment, the alert threshold that is retrieved can be selected based on one or more of the current day, the current time, and the current number of employees in location 100. Using different alert thresholds for different days allows for higher alert thresholds to be used on days that are expected to be busy. These higher alert thresholds allow employees to continue to work to keep the location operational instead of constantly interrupting their work. Using different alert thresholds for different times of day can be useful to avoid sending alerts during times of the day when employees are normally not performing operations that would block pathways. This avoids the issuance of unneeded alert messages. Having different alert thresholds for different numbers of employees in the location also allows for higher thresholds when the number of employees is low since a lower number of employees is associated with a lower number of obstructed pathways. As the number of employees increases, the alert threshold drops because it is more likely that a significant number of pathways will be blocked by employees as the number of employees increases.

At step 208, alert subsystem 306 compares current visitor count 304 with the retrieved alert threshold for triggering a “clear pathway” alert. If the count is above the threshold, alert subsystem 306 determines at step 209 if an earlier “clear pathway” alert was issued. If an earlier alert was not issued, alert subsystem 306 transmits a “clear pathway” alert to employees at step 210. The “clear pathway” alert instructs employees: 1) to stop the activity they are currently performing, such as restocking, cleaning or repairing; 2) to remove objects blocking aisles and pathways; and 3) to make themselves available to assist customers and visitors. In a retail store environment, this facilitates access to products on shelves. In some embodiments, the objects that are to be removed are generally obstacles or obstructions in the aisles that are used for restocking, cleaning and/or maintenance. In one embodiment, alert subsystem 306 transmits the alert by broadcasting a wireless signal 307, such as a radio signal or infrared signal, that is received by respective receivers 320 and 322 positioned near or on employees. The radio signal can contain or represent an audio signal that is automatically played by receivers 320 and 322 so that the employees can hear the alert. Additionally or alternatively, the radio signal can contain or represent a graphic and/or text signal that is shown on the displays of receivers 320 and 322. The alerts may be simulcast to all of the receivers 320 and 322 or may be broadcasted individually to the receivers 320 and 322. In addition, the alert may be sent to all of the receives in the location or to only those receivers held by employees whose jobs would require them to occasionally block aisles or pathways within location 100.

At step 211, employees remove obstacles from the aisles and pathways in response to the alert message. The process then returns to step 200 where entrance/exit sensors 300 continue to sense visitors as they enter and exit the location. This results in modifying the count of visitors in the location at step 202. The current number of employees is then retrieved once again at step 204 and a current day and time is retrieved at step 205. An alert threshold is retrieved at step 206, which may be the same alert threshold previously retrieved or may be a new alert threshold due to the change in day, time, or number of employees. If the new visitor count 302 continues to be above the alert threshold, the process determines if an earlier alert was issued at step 209. If an earlier alert was issued, the process returns to step 200 and steps 200-208 are repeated.

If visitor count 304 is below the threshold at step 208, the process continues at step 212 where it determines if an earlier alert was issued. If an earlier alert was not issued, the process returns to step 200 and steps 200-208 are repeated. If an earlier alert was issued at step 212, a “resume” message is transmitted at step 214 and is sent from alert system 307 to employee receivers 320, 322. The “resume” message instructs employees to resume the task that had been interrupted such as restocking, cleaning, or maintaining. After step 214, the process returns to step 200 and steps 200-208 are repeated. When a “resume” message is sent, the system is essentially reset such that when steps 209 or 212 are performed after a “resume” message has been transmitted, the method behaves as if an earlier alert has not been issued.

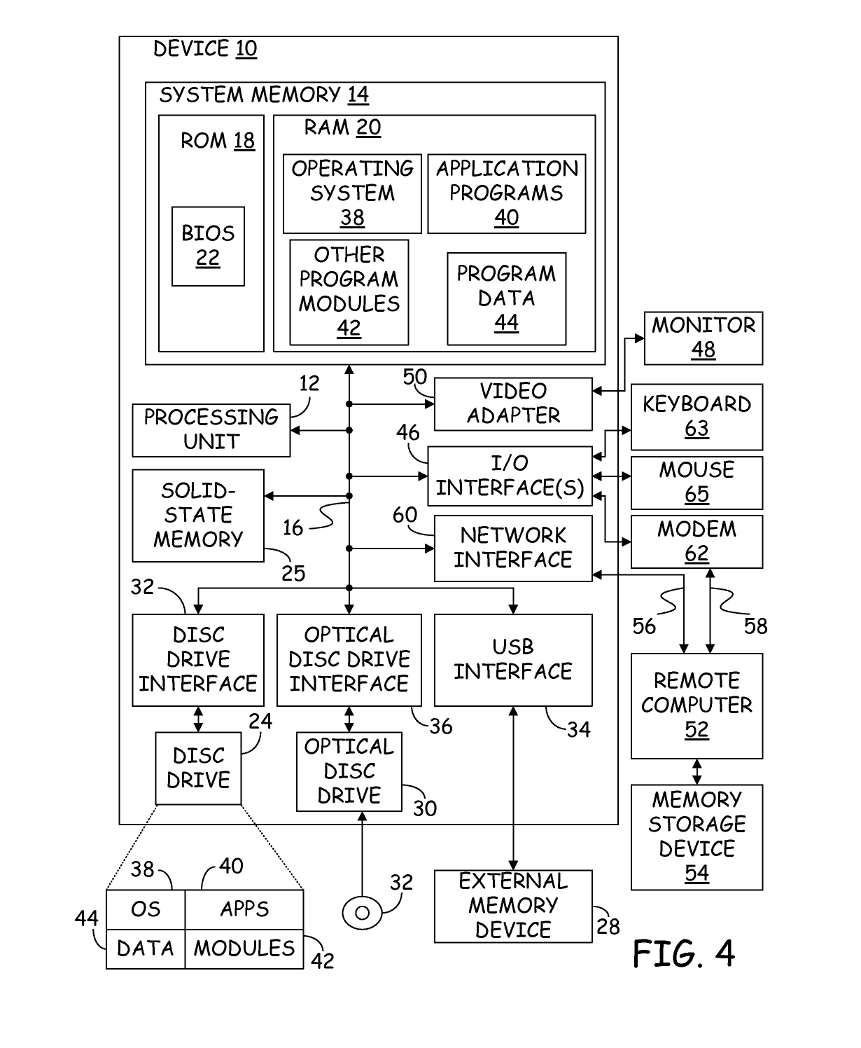

FIG. 4 provides an example of a computing device 10 that can be used as a server device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing server 114 including programs for implementing visitor counter 302, alert subsystem 306, and clock/calendar 310, for example. Program data 44 may include data such as number of employees 308, alert thresholds 312, and visitor count 304, for example.

Processing unit 12, also referred to as a processor, executes programs in system memory 14 and solid state memory 25 to perform the methods described above.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 4. The network connections depicted in FIG. 4 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46. Order 206 is received through either network interface 60 or modem 62.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 4 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A system comprising:
a counting subsystem that maintains a count of visitors currently in a location having aisles;
an alert subsystem that monitors the count and that issues an alert to employees in the location in response to the count exceeding a threshold, wherein the alert instructs employees to remove obstacles from the aisles.

2. The system of claim 1 wherein the counting subsystem counts a number of visitors who have entered the location and the number of visitors who have left the location to form the count of visitors currently in the location.

3. The system of claim 1 wherein the alert issued by the alert subsystem further instructs employees to move out of certain aisles to be of further assistance to visitors in the location.

4. The system of claim 1 wherein the alert subsystem issues the alert by transmitting a radio signal to receivers held by the employees.

5. The system of claim 4 wherein the radio signal represents an audio signal.

6. The system of claim 4 wherein the radio signal represents a graphic signal.

7. The system of claim 1 wherein the alert subsystem further determines a time of day and issues the alert in response to at least a combination of the count of visitors in the location and the time of day.

8. The system of claim 1 wherein the alert subsystem further retrieves a count of employees in the location and issues the alert in response to at least a combination of the count of employees in the location and the count of visitors in the location.

9. A method comprising:
determining a number of visitors in a store;
selecting an alert threshold;
comparing the number of visitors to the alert threshold; and
when the number of visitors exceeds the selected alert threshold, broadcasting an alert to store employees to facilitate access to products on shelves in the store.

10. The method of claim 9 wherein determining a number of visitors in the store comprises counting the number of visitors who enter the store, counting the number of visitors who leave the store and determining a difference between the number of visitors who enter the store and the number of visitors who leave the store.

11. The method of claim 9 wherein the alert instructs store employees to stop stocking shelves.

12. The method of claim 9 wherein the alert instructs store employees to remove obstacles from aisles in the store.

13. The method of claim 9 wherein selecting an alert threshold comprises selecting the alert threshold based on a day of the week.

14. The method of claim 9 wherein selecting an alert threshold comprises selecting the alert threshold based on a time of day.

15. The method of claim 9 wherein broadcasting an alert comprises transmitting a wireless signal to receivers positioned near the store employees.

16. A computer-readable medium having stored thereon computer-executable instructions that when executed by a processor cause the processor to perform steps comprising:
receiving an indication that additional visitors have entered a store;
determining that the additional visitors cause a total number of visitors in the store to exceed a value;
in response to the total number of visitors exceeding the value, sending a message to store employees to make themselves available to help visitors.

17. The computer-readable medium of claim 16 wherein determining that the total number of visitors exceeds a value comprises selecting the value based in part on a time of day.

18. The computer-readable medium of claim 16 further comprising determining that visitors have left the store and in response sending a second message to store employees to continue stocking shelves.

19. The computer-readable medium of claim 16 wherein sending a message to store employees comprises broadcasting a message to receivers held by the store employees.

20. The computer-readable medium of claim 16 wherein sending a message to store employees to make themselves available to help visitors further comprises sending a message to store employees to remove restocking equipment from the aisles.
